(19) United States
(12) Patent Application Publication
(10) Pub. No.: US 2007/0044685 A1
(43) Pub. Date: Mar. 1, 2007

(54) Mosaic marble flooring and driveway system

(76) Inventor: Harvinder Khanna, Maple (CA)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/481,713

(22) Filed: Jul. 6, 2006

Related U.S. Application Data
(60) Provisional application No. 60/713,811, filed on Sep. 1, 2005.

(51) Int. Cl. C04B 16/00; C04B 7/00; C04B 14/00; C04B 24/00

(52) U.S. Cl. 106/712; 106/737; 106/734

(57) ABSTRACT

A novel marble floor comprising a base, a vapor barrier, a concrete slab, grout comprising portland cement and marble pieces, and scrap marble pieces surrounding the grout.

### CLAIM OF PRIORITY

This application claims benefit to provisional application 60/713,811 filed on Sep. 1, 2005, entitled “Mosaic Marble Flooring and Driveway System”, which is incorporated in its entirety.

### FIELD OF THE INVENTION

The present invention is directed to the area of scrap marble recycling. In particular, the present invention is a method and system for using scrap pieces of marble to produce floors, driveways and the like.

### BACKGROUND OF THE INVENTION

Marble is one of the most beautiful stones in the world. Marble flooring culminates beauty and luxury. There are a number of prior patents and technologies directed to stone and marble recycling.

U.S. Pat. No. 3,963,846 provides surface elements such as tiles or panels consisting of a thin lamina of natural stone bonded to a backing, consisting of a multicultural paper core material of substantially greater thickness than said lamina, which at least on the side remote from the stone lamina has a skin of tenacious sheet material bonded thereto. The resultant composite element is extremely rigid, light and cheap to produce in comparison with solid stone and may be cut into any desired shape and used as a substitute for solid stone, but with the advantages of lightness, strength and low cost thus enabling such surface elements to be used for many purposes where the use of solid stone would be economically or practicably prohibitive.

U.S. Pat. No. 4,092,393 discloses a marble or similar natural stone having a plurality of plane faces that are stacked in a liquid-tight container. Said pieces are arranged with their plane faces facing each other so as to form a plurality of parallel layers. Thereafter, a vacuum is applied in said container and, while maintaining the latter under vacuum, a fluid harden able binding composition, such as a synthetic resin, is then poured into said container. Said composition flows down through the interstices existing in and around the stack of pieces, until it completely covers said stack. Thereafter, the inside of the container is brought to atmospheric or super atmospheric pressure, thus causing said binding composition to thoroughly penetrate into all said interstices and into all the cavities of the pieces opening on their surface, and then said binding composition is allowed to harden.

U.S. Pat. No. 4,640,850 discloses a composite facing slab that comprises a sheet of natural stone, such as marble, and a protective layer constituted by a sheet of transparent glass. The latter is fixed to the face of the stone sheet intended to remain visible with the inter-positioning of an interlayer of transparent thermoplastics material which can adhere to both the sheets and fills the surface defects (pores, cavities, cracks and the like) of the stone sheet.

U.S. Pat. No. 5,586,925 discloses an apparatus and method for artificially weathering large amounts of marble by use of a horizontally disposed drum having a stone lined interior surface. The drum houses a large quantity of marble having similar surface hardness together with a slurry of abrasive material including silica, clay, and gravel which operates to cushion the marble from chipping during tumbling of the marble. The stone lining of the drum absorbs the impact of marble to reduce or prevent chipping of the marble. The marble and slurry are rotated at a particular speed for a predetermined amount of time. Various types of acid can also be inserted into the mixture providing a faster processing time and surface etching not possible with straight abrasion techniques. The processed marble is removed from the drum and sliced in half so to provide two pieces of weathered tile each having a flat mounting surface.

U.S. Pat. No. 5,454,751 discloses an improved method of finishing surfaces having irregular stepped portions or other edges and improved apparatus therefor. The method of the present invention includes rough finishing the surface by utilization, of a rotary tool with a first abrasive pad attached thereto. The first abrasive pad includes an abrasive body portion with an outer peripheral edge. A substantially flexible outer rim portion extends outward from the peripheral edge of the pad. According to a second step of the present invention, finished sanding of the surfaces is accomplished by utilization of a rotary tool with a second abrasive pad attached thereto. The second abrasive pad includes a backing substrate and at least one abrasive segment attached thereto. The total abrasive surface encompassed by the abrasive segment is from about 1% to about 30%. With the finishing pad of the present invention hydraulic suction is minimized thereby allowing greater forces to be placed on the abrasive pad for increasing abrasive cutting efficiency of a particular sized abrasive grit.

U.S. Pat. No. RE38,364 discloses an improved method of finishing surfaces. This method consists of both hardening and polishing a concrete surface and includes the steps of first applying to the concrete surface a hardening/densifying silicate compound, allowing the compound to remain in contact with the surface for a period of time sufficient to allow it to soak into the surface of the concrete, cleaning the surface and allowing it to dry, and polishing the surface with a diluted silicate polishing compound. The polishing step includes the steps of applying to the concrete surface a diluted silicate polishing compound, mechanically polishing the concrete surface with a rotary polishing machine, using pads or disks or drums, cleaning the concrete surface, and repeating said steps with polishing pads or disks of increasingly finer grit until the surface obtains an aesthetically desirable level of shine.

U.S. Pat. No. 5,273,620 discloses a method of providing colored design inlay on a granite or marble surface comprising the steps of providing a stone surface; preparing the stone surface; providing colored glass particles; providing a liquid base adhesive; mixing the particles and adhesive; pouring the mixture onto the stone; allowing the mixture to harden; grinding and polishing the mixture; and, etching the finished product. The means comprises the colored glass particles and the liquid base adhesive along with the polishing and etching tools.

U.S. Pat. No. 4,902,538 discloses a process for the protection of stone materials, marble, bricks, and concrete, and structures made from such materials, against the decay caused by atmospheric agents and pollutants, by applying to the surface of said materials or structures a mixture which is constituted by: polytetrafluoroethylene in the form of a fine powder; a perfluoropolyether not bearing functional groups; and/or a perfluoropolyether or a fluoropolyether having a chain end, or both chain ends, constituted by functional groups which are capable of forming a chemical and/or physical bond with the material to be protected. The invention also relates to a process for preventing, on the normal materials for building industry and lining materials, the decay effects caused by writings made by using spray paints or brush paints, inks, and the like.

U.S. Patent Application No. 20040169303 discloses a process for the production of marble conglomerate slabs, starting from marble sand and/or granulates, additivated with binders, of the kind comprising a step of mixing the raw materials, a step of placing the mixture on a conveyor belt or on moulds, an under vacuum vibro-compaction step and a following step of polymerisation of the binder, further comprising a step of placing a protective sheet on said conveyor belt or on the base of said moulds, before pouring the mixture, and on said mixture, said protective sheet being comprised of hydrosoluble plastic material in such a way to coat the mixture above and at the bottom before the vibro-compaction step, said hydrosoluble material sheet being automatically removed, after the binder polymerisation step, from the water of the slab finishing workings.

U.S. Patent Application No. 20040091670 discloses a coated bathroom or kitchen component product that includes a transparent polymerized resin and inserts of gravel of marble and/or other stones embedded substantially uniformly in the transparent polymerized resin. The inserts have a coplanar leveled surface at a surface of the component. The inserts are surrounded by a surface of the polymerized resin defining surface depressions having a lowest depression surface in a region between inserts and the surface of the polymerized resin rising form the lowest depression surface to the level of the surface of the component adjacent to the inserts.

U.S. Patent Application No. 20030159685 discloses an article for manufacture of marble asphalt with use of a specific marble rock unique to certain geographic regions and a process for which rock is removed and thus eliminates stress on rock composition, providing an asphalt blend or as an additive. The marble rock may require reformulation depending on the process of normal asphalt manufacture process, methods or other generally accepted uses or product classification.

U.S. Patent Application No. 20030159626 discloses an article for manufacture of marble concrete with use of a specific marble rock unique to certain geographic regions, and process for which rock is removed and thus eliminates stress on rock composition, providing a concrete blend or as an additive. The marble rock may require reformulation depending on the process of normal concrete manufacture process, methods or other generally accepted uses or product classification.

While there have been a number of systems directed to the use of marble and for creating flooring, there has been no system for laying mosaic marble flooring and the like.

It is an object of the present invention to provide a flooring system using marble pieces.

It is a further object of the present invention to provide a novel and unique use of marble for indoor and outdoor use.

It is a further object of the present invention to provide a method of heating a marble driveway.

It is yet a further object of the invention to provide a novel grout for use in flooring.

### SUMMARY OF THE INVENTION

In a first embodiment, the present invention is a grout for use with a marble system comprising of portland cement and marble pieces.

In accordance with a further aspect, the present invention is a novel marble floor comprising of a base; a vapor barrier; a concrete slab; grout comprising portland cement and marble pieces; and scrap marble pieces surrounding the grout. The novel marble flooring further comprises a heating system for heating the slab.

In accordance with yet a further aspect, the present invention is a method for laying the marble mosaic driveway that comprises of laying a floor area with a gravel base; laying a safe barrier over the gravel base; laying a concrete slab with rebar reinforcement; applying a plurality of marble waste pieces; and

surrounding the marble pieces with a grout comprising portland cement and marble slaps.

### BRIEF DESCRIPTION OF THE FIGURES

FIGS. 1 through 3 are perspective section views of the mosaic marble system of the present invention.

FIG. 4 is a diagram of a heating system of the invention for use in a cold environment.

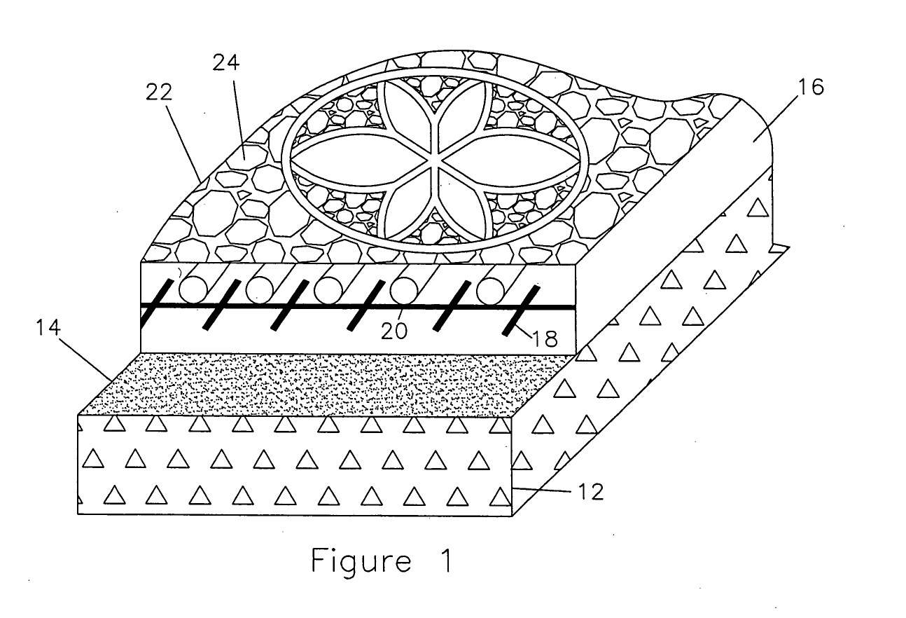

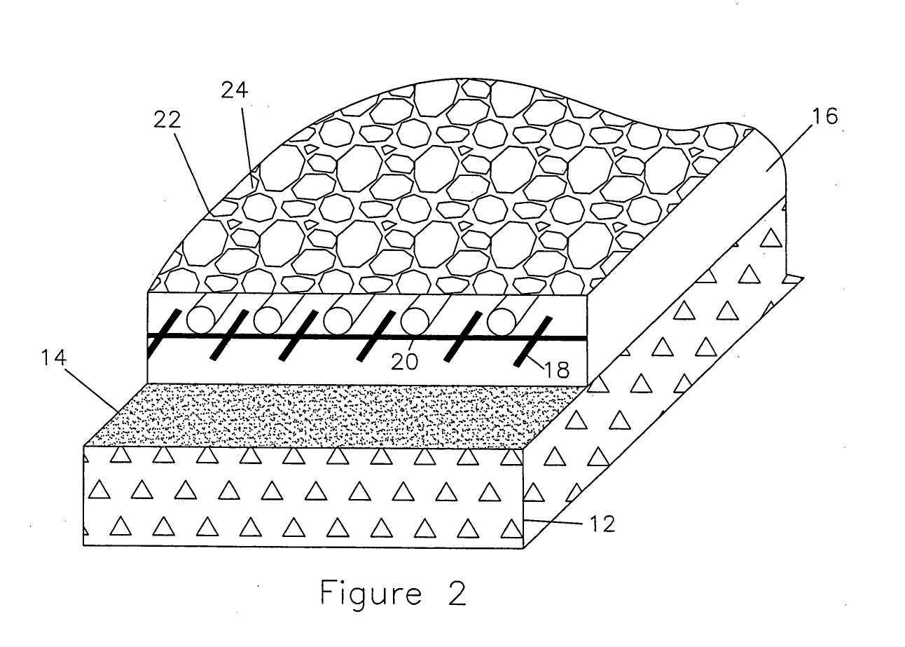

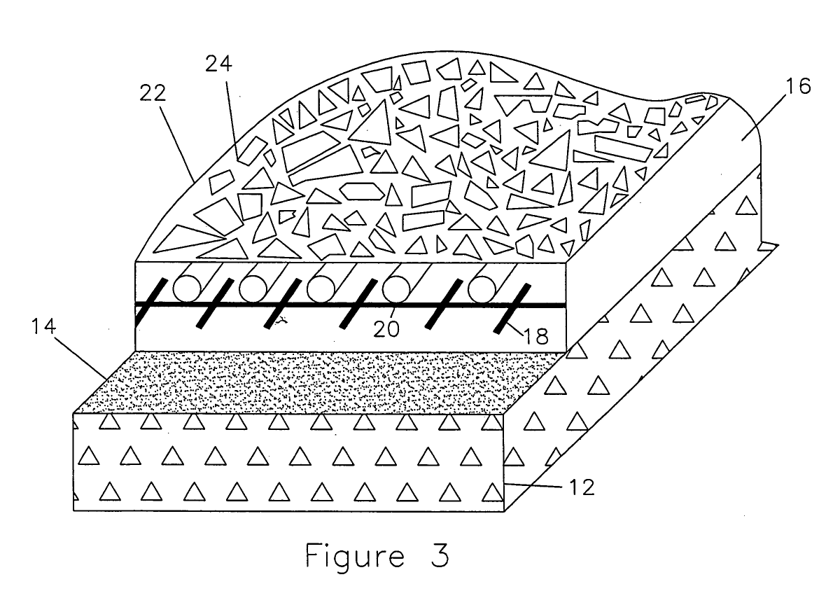

### DESCRIPTION OF THE PREFERRED EMBODIMENT

The invention is described with reference to the enclosed Figures wherein the same numbers are used where applicable. The present invention is directed to a system for creating flooring, driveways and the like by using marble pieces and scraps. The goal of the invention is to provide a mosaic marble floor. In a most preferred embodiment, the invention comprises a driveway or flooring system. The system, as will be described herein, comprises a marble based system. The flooring consists of a series of layers. These include a gravel base 12, vapor barrier 14, concrete slab 16, rebar inserts 18, optimal plastic heating pipes 20, novel grout with marble chips 22 and scrap marble pieces (2″ to 10″ in length and width) 24.

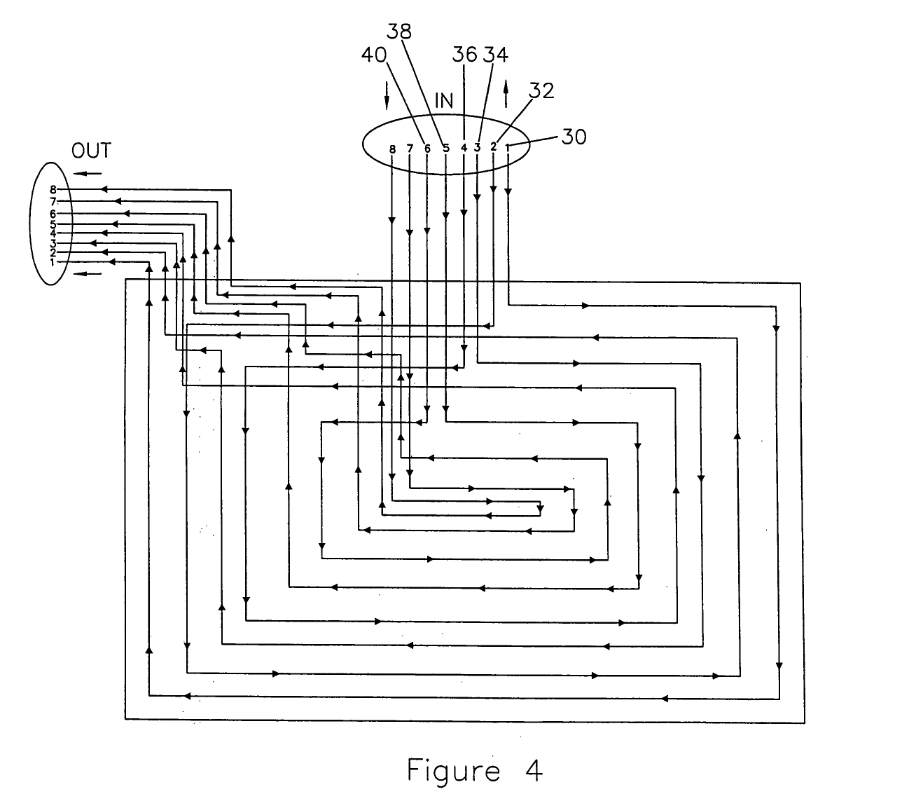

The method comprises steps to put the system in a driveway or pathway. First, a floor area is poured with a 4′ to 5′ gravel base 12. Next, a vapor barrier 14 is laid down with a concrete slab 16 containing Rebar inserts 18 and half-inch plastic tubes 20 inserted as shown. The plastic tubes 20, as will be discussed herein, provide a heat barrier for use. The sequence for laying down the plastic tubes 20 is shown in FIG. 4.

The border comprises concrete slab installation with the mortar mix of five parts of sand and one part of Portland cement. After the border dries or hardens for twenty-four hours, marble pieces 22 are installed which are small waster/scrap pieces of marble.

When the marble dries and sets for at least twenty-four hours, the grout mix is prepared. The grout mix is one part of portland cement and one part of marble chips. A desired colored sand can also be added. The grout is then poured into the joints. The grout with pieces of marble (2″×6″) settles into the joints.

Finally, the floor is ground with a series of abrasives. In a most preferred embodiment, four types of abrasives are used. No. 46 is a course abrasive. Secondly, No. 60 is used and thirdly, No. 80 is used. Finally, the fourth abrasive is used for smooth finishing which is No.1 20 abrasive. Once the final grinding has been completed, the entire driveway looks like a one slab of marble.

Referring to FIG. 4, the purpose of the plastic tubes in the concrete slab serves a dual purposes. These plastic tubes 20 minimize the effect of frost, as heated air in the plastic tubes 20 act as a thermal barrier between the gravel base 12 and the concrete slab 16. These plastic tubes slightly warm the slab and the marble floor, which helps to melt the snow in winter. The tubes can use hot air from the house, which keep these tubes warm. Some examples include the furnace vent 30, hot water tank vent 32, gas fireplace vent 34, dryer vent 36, kitchen fan vent 30, and wash rooms fan vent 40. The heated waste air from the house is collected and passed through the plastic tubes.

The present method can also be used to lay a mosaic marble driveway in a warm temperature environment. With the exception that when pouring the slab, plastic tubes are not required to warm the slab, the same structure and process is implemented. In all other aspects, the procedure and composition are the same.

In a further embodiment, the present invention can be used to place mosaic marble floor on a plywood surface. In this embodiment, a mesh of steel is nailed onto a plywood subrate. The border comprises a mix of five parts of sand and one part of Portland cement. Next, the floor is polished with polishing abraders. The abraders used are No. 220, No. 320, No. 400, No. 600, No. 800 and No. 1200 respectively. Finally, for a glass finish, No. 5× is used. The amount of abrasion depends on the desired glossiness of the finish.

It is to be noted that the strength of the mosaic marble lies in the grout. Marble is a soft stone, which cannot alone handle the weight of a car or truck in a driveway. For the mosaic marble driveway system, the technique used installs the broken pieces in such a way that the eighty percent (80%) of the car's weight stays on the grout.

The flooring of the present invention has a number of advantages. The first advantage of mosaic marble flooring is that it is very strong with a life expectancy of fifty to one hundred years. The second advantage of the present invention over the regular marble is that the grout in regular marble is 1/64 inches lower than tile, which causes the dirt to stay on the grout. In the mosaic marble, the grout is completely level with the marble pieces so it appears to be one slab.

The difference between mosaic marble and the regular marble is that in the regular marble, polished marble is used and in the mosaic marble, unpolished marble is used. The marble must first be installed, then the marble can be sanded and polished.

The present invention has been described with reference to the above preferred embodiment. The true nature and scope of the present invention is to be determined with reference to the claims.

I claim:

1. A grout with use comprising:
portland cement; and
marble pieces.

2. The novel grout of claim 1 further comprising of a colored sand.

3. A novel marble floor comprising:
a base;
a vapor barrier;
a concrete slab;
grout comprising portland cement and marble pieces; and
scrap marble pieces surrounding the grout.

4. The novel marble flooring of claim 3 further comprising a heating system for heating the slab.

5. A method for laying a marble mosaic driveway comprising:
laying a floor area with a gravel base;
laying a safe barrier over the gravel base;
laying a concrete slab with rebar reinforcement;
applying a plurality of marble waste pieces;
surrounding the marble pieces with a grout comprising Portland cement and marble scraps.

6. The method of claim 5 further comprising the addition of a heating system in the concrete slab.

7. The method of claim 6 wherein the heating option comprises a plurality of pipes connected to a source of heated air.
